(19) United States
(12) Patent Application Publication
(10) Pub. No.: US 2025/0200034 A1
(43) Pub. Date: Jun. 19, 2025

(54) SYSTEM AND METHOD FOR MINING DATA USING GENERATIVE AI

(71) Applicant: Yahoo Ad Tech LLC, New York, NY (US)

(72) Inventors: Ariel Raviv, Haifa (IL); Alexander Shtoff, Haifa (IL)

(21) Appl. No.: 18/544,766

(22) Filed: Dec. 19, 2023

(51) Int. Cl. G06F 16/2452; G06F 40/40; G06Q 30/0242

(52) U.S. Cl. CPC G06F 16/24522; G06F 40/40; G06Q 30/0242

(57) ABSTRACT

One or more computing devices, systems, and/or methods that provide an interactive reporting system for analyzing and reporting on campaign related data and mining insights using generative AI are provided. In an example, a user interface is configured to receive a natural language request and display a natural language response. A serving system is coupled to a data store housing campaign data sets and comprises a dedicated campaign large language model (LLM) configured to convert the natural language request to a suitable query capable of being run against the campaign data sets and to run the query against the data sets, to receive output from the query, to encode relevant query output together with the natural language request and/or the suitable query into an encoded output, and to decode the encoded output to generate a natural language response to the natural language request.

### BACKGROUND

Many applications, such as websites, social media applications, etc. may provide platforms for viewing media, such as advertisement media. For example, a user may interact with a service. While interacting with the service, selected media may be presented to the user automatically. Ever increasing amounts of data and metrics relating to such media and its presentation to users are being generated, monitored and/or collected by such platforms or third parties. As such, it is increasingly challenging for decision makers (e.g., advertising campaign managers, marketers, etc.) to mine relevant data sets in order to glean useful insights from such data and metrics.

Currently, advertisers have a limited set of options available to them to assist them in mining their ever-increasing campaign related data sets. They may rely on conventional, predefined graphs and tables to help them gain insight into their data or they may build custom queries (data store information requests expressed in programming language, e.g., SQL) to help them mine data in a manner that they feel may help them gain insight. The latter process requires some proficiency with building queries and understanding of the data set contents and structure-many marketers do not have such proficiency, and would rather focus on other tasks.

### SUMMARY

In accordance with the present disclosure, one or more systems, computing devices and/or methods are provided. In an example, an interactive reporting system comprises a serving system comprising a dedicated campaign large language model (LLM) configured to convert a natural language request received at a user interface to a query capable of being run against stored data sets and to run the query against the data sets. The serving system is further configured to receive output from the query, to encode relevant query output, the natural language request, and/or the query into an encoded output, and decode the encoded output to generate a natural language response to the natural language request.

In an example, the campaign LLM comprises a dedicated transformer type large language model created through training on one or more large campaign related data sets.

In an example, the campaign LLM comprises a first and second dedicated LLM. The first dedicated LLM is trained on one or more large campaign data sets selected to create a dedicated campaign LLM that is tailored to encode queries from user natural language requests. The second dedicated LLM is trained on one or more large campaign data sets selected to create a dedicated campaign LLM that is tailored to generate suitable natural language responses to such requests.

In an example, the campaign LLM comprises a federated LLM in which each federation has been created by training each federation on an individual user data set that is characteristic of and unique to an individual user corresponding to the individual user data set. In an example, each individual user data set comprises the individual user's prior requests, query information, and feedback information.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for providing natural language insight mining and reporting.

FIG. 5 is a component block diagram illustrating an example campaign reporting system for providing natural language insight mining and reporting.

FIG. 6 is a component block diagram illustrating an example natural language request and corresponding query in accordance with one or more embodiments set forth herein.

FIG. 7 is component block diagram illustrating an example client device hosting an example user interface in a system for providing natural language insight mining and reporting in accordance with one or more embodiments set forth herein.

FIG. 8 is an illustration of a scenario featuring an example non-transitory machine readable medium in accordance with one or more embodiments set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

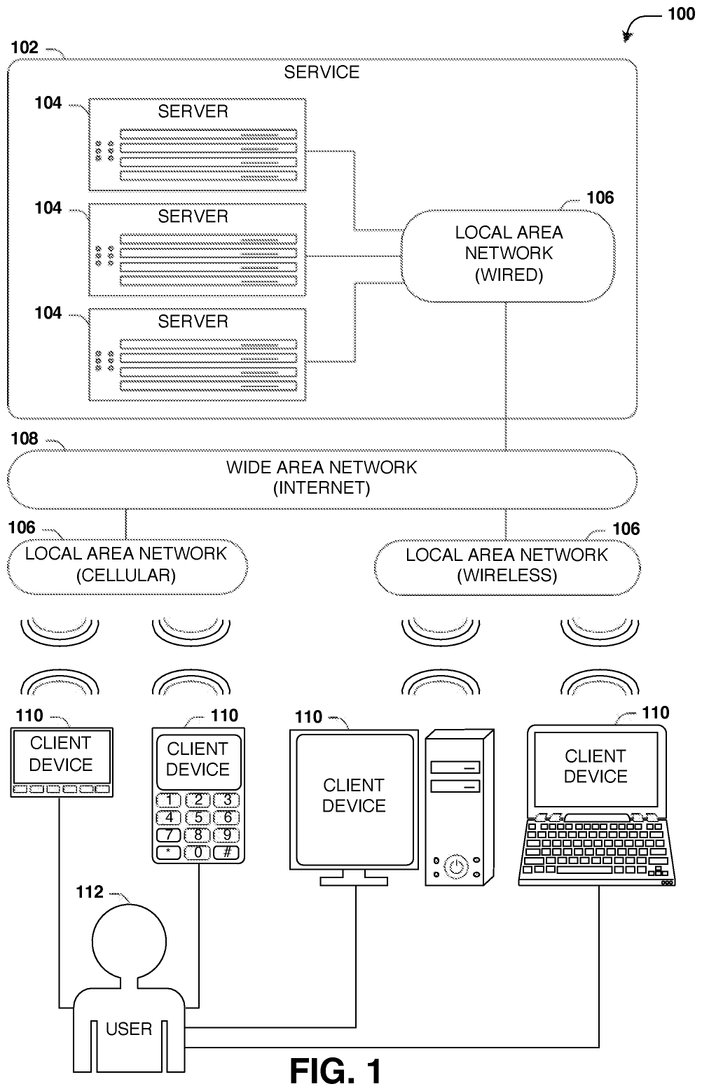

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP)). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ different architectures, may be compliant or compatible with differing protocols and/or may interoperate within the local area network 106. Additionally, a variety of local area networks 106 may be interconnected; e.g., a router may provide a link between otherwise separate and independent local area networks 106.

In scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

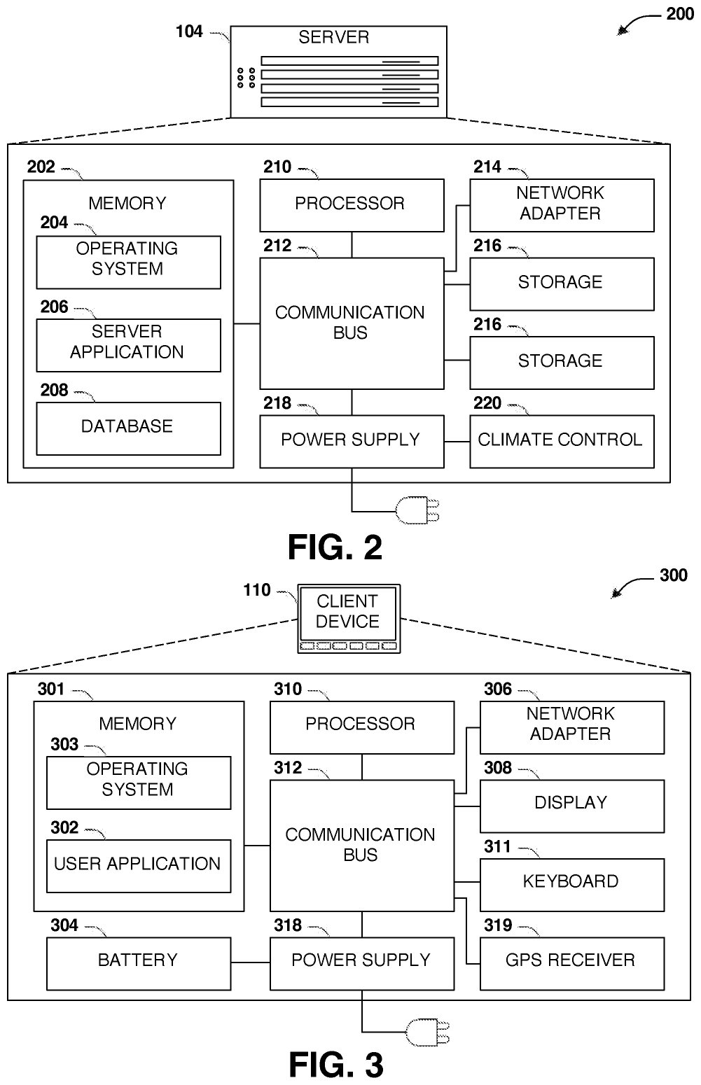

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic architecture diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

### 2. Presented Techniques

One or more systems and/or techniques for mining large data sets to generate campaign related insights in an automated and interactive manner using generative AI and natural language are provided.

Campaign data may be understood to include generally any data associated with a campaign implemented via a content serving system. Content serving systems serve content items, such as advertisements and/or other types of content, to users. In some examples, a content serving system may provide content items (e.g., news articles, informational articles, videos, advertisements, images, links, etc.) to be presented to users through user interfaces on the users' computing devices via pages associated with the content serving system (e.g., pages providing search engines, email services, news content, communication services, social network feeds, etc.). For example, the pages may be associated with (e.g., accessed using) one or more applications (e.g., web applications, mobile applications, etc.), one or more websites, etc. associated with the content serving system. A content serving system may provide content items to be presented in locations throughout the pages (e.g., one or more areas of the pages configured for presentation of content items). At any given time, there may be hundreds of thousands of content items available to display to users.

Content items to be served to users may be selected in various ways. In some content serving systems, content may be selected through a real-time auction hosted by the content serving system. For example, a content provider (e.g., merchants, advertisers, etc.) may provide advertisements or may provide a product or service catalog, from which advertisements may be generated, to the content serving system. The content serving system may automatically create a personalized experience for a user accessing pages by choosing advertisements, or products or services from the catalog, that may be of interest to the user and displaying such content items through the pages to the user. The content items that are selected to be presented to the user may be selected as part of the real-time auction. The real-time auction may take into account parameters selected by the content provider such as, e.g., budget considerations and audience targeting considerations of the content provider. An advertisement or a product or service from the catalog with the highest bid may be selected and provided as a content item to the user by the content serving system.

Content campaigns (e.g., advertisement campaigns) may be used by the content serving system as part of the selection process. In general, any suitable campaign type may be utilized in the embodiments described herein. In a non-limiting example, one suitable type of campaign is a retargeting campaign. A retargeting campaign may be used to serve users that already showed an interest in a content item at a content provider page (e.g., showed an interest in a particular service by reading a description of the service through a website of an online merchant or advertiser). When the user visits a page supported by the content serving system, the content item (e.g., a description and link to purchase the service) may be displayed to the user as a retargeted content item. Another type of campaign is a prospecting campaign. The prospecting campaign has the goal of expanding an audience of a content provider by presenting content items to users that have not directly interacted with the content items. Various models (e.g., machine learning models) may be used to leverage additional signals such as, e.g., search history, user location, user demographic information in order to predict what content items may be relevant and interesting to the user.

The content serving system may include a data store sufficient to support its functionality, such as for example one or more relational databases (e.g., MySQL®, PostgreSQL®), and/or document-oriented databases (e.g., Firebase® Realtime, MongoDB®). The data store may house data related to content items, campaigns, etc. Content item related data may include, in some non-limiting examples, catalog information and metadata, pointers to product or service content files, media files, etc. Campaign related data may include, in some non-limiting examples, campaign parameters (e.g., budget, campaign type, duration, target user segment, etc.), various campaign modeling data, KPIs, etc. Campaign related data may also include, for example, data relating to the outcome or results of campaigns, such as for example, event data (e.g., content item impressions/views, clicks, conversions, user segment data associated with events and/or non-events, device type, location, etc.), advertisement related commercial information (e.g., sales data), campaign metrics and KPIs, etc.

In general, the amount and complexity of campaign data generated and stored in relation to a content delivery system may make it difficult for content provider users (e.g., marketing managers or other advertisement professionals, media consultants, etc.) to mine the data and generate useful reports and/or to glean useful insights from the data. For example, some advertisement content delivery systems may cluster users into segments based on various factors, resulting in potentially thousands of segments in the system (e.g., dog owners, new parents, audiophiles, etc.), and a single user may be included in tens of them. Additionally, user traits such as demographic data and other contextual data (e.g., device type) may further increase campaign data complexity.

The systems and methods of the embodiments described herein provide for simple and effective data mining and insight generation of large campaign data sets using only natural language requests and/or without using data store information requests expressed in programming language (e.g., SQL). Using a dedicated campaign large language model (LLM) connected to a data store of campaign related data, the systems and methods allow for a user to use natural language requests to effectively mine campaign related data and to receive natural language responses in return. Utilizing the systems and methods herein, virtually any marketing user may mine campaign data sets without having to rely on predefined reports and without having to be savvy with data mining techniques and technology (e.g., SQL queries).

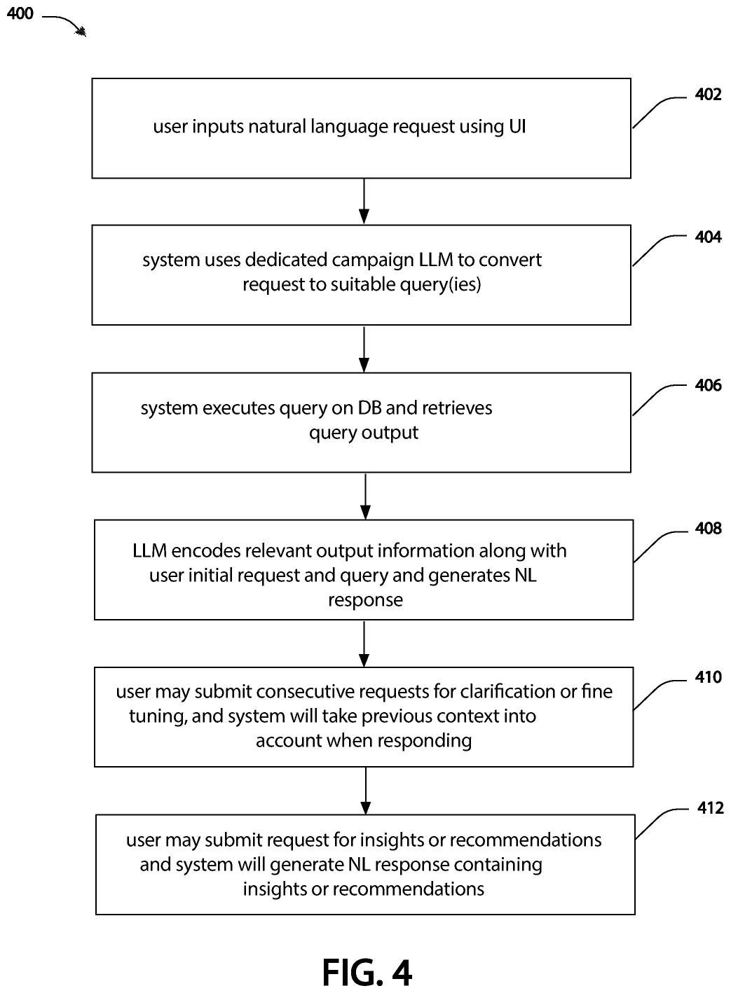

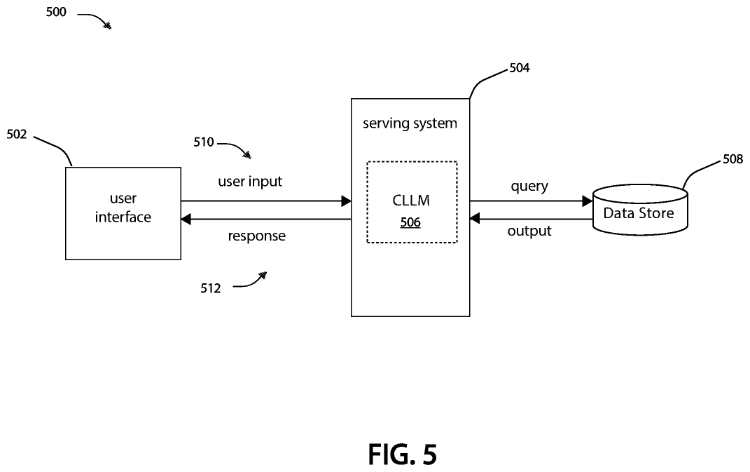

An embodiment of mining campaign data interactively using natural language is illustrated by an example method 400 of FIG. 4, and is further described in conjunction with a campaign reporting system 500 of FIG. 5. In some examples, the campaign reporting system 500 comprises a user interface 502, a serving system 504 implementing a campaign large language model (campaign LLM) 506, and a data store 508 that is communicatively coupled to the serving system 504. In some embodiments, campaign reporting system 500 may be deployed as part (tightly or loosely integrated) of a content serving system or platform (not shown). In some embodiments, campaign reporting system 500 may be deployed independently of a content serving system or platform.

In general, user interface 502 may comprise any suitable interface sufficient to allow a user to interact with the campaign reporting system of the embodiments described herein to generate reports on and insights into campaign related data. In some embodiments, user interface 502 comprises an application (e.g., browser, app, etc.) running on a client device that is communicatively coupled to serving system 504 and that is configured to receive natural language user input 510 (e.g., questions, instructions, etc.) via text, audio, screen touches on control elements, etc., and to present system output 512 (e.g., natural language text, audio, video, visual data representations such as graphs, charts, tables, etc.) to the user.

In some embodiments, serving system 504 hosts campaign large language model (campaign LLM) 506. In general, campaign LLM 506 may comprise any dedicated large language model sufficient to provide the functionality described herein. In some embodiments, campaign LLM 506 may comprise a dedicated transformer type large language model created through training on one or more large campaign related data sets. In some embodiments, campaign LLM 506 may comprise a dedicated pretrained large language model created that may be tuned through continued training on campaign data sets and/or interactions from users (query/response data, context data, human annotations, etc.). In some embodiments, campaign LLM 506 may be deployed on a serving system external to campaign reporting system 500, and serving system 504 may be configured to interact with the externally hosted campaign LLM via, e.g., one or more APIs.

In some embodiments, campaign LLM 506 may be communicatively connected to data store 508. In general, data store 508 may be any data store sufficient to support the functionality of campaign reporting system 500. In some embodiments, data store 508 may be a shared data store with a content serving system (not shown). In some embodiments, data store 508 may be a data store that is not integrated with a content serving system and/or may comprise, in whole or in part, a third party service (e.g., weather service data store). In some embodiments, data store 508 may comprise one or more relational databases (e.g., MySQL®, PostgreSQL®), and/or document-oriented databases (e.g., Firebase® Realtime, MongoDB®). Data store 508 may house data related to content items, campaigns, etc. Content item related data may include, in some non-limiting examples, catalog information and metadata, pointers to product or service content files, media files, etc. Campaign related data may include, in some non-limiting examples, campaign parameters (e.g., budget, campaign type, duration, target user segment, etc.), various campaign modeling data, KPIs, etc. Campaign related data may also include, for example, data relating to the outcome or results of campaigns, such as for example, event data (e.g., content item impressions/views, clicks, conversions, user segment data associated with events and/or non-events, device type, location, etc.), advertisement related commercial information (e.g., sales data), campaign metrics and KPIs, etc.

In some embodiments, serving system 504 and/or campaign LLM 506 may be configured to establish a communicative connection with data store 508 upon an event (e.g. a session request), or be statically connected to data store 508, or both. In some embodiments, serving system 504 and/or campaign LLM 506 may be configured such that campaign LLM 506 may run queries on data store 508, or cause queries to be run on data store 508.

With reference to FIG. 4, at 402, a user of campaign reporting system 500 (e.g., a marketer, content manager, account manager, etc.) may input a natural language request via user interface 502. In one non-limiting example, a user may type into a text field element of a screen provided on a client device by user interface 502, a natural language string, such as: “give me a list of best performing products”, “what were the least performing segments of my campaign X”, “give me a list of worst performing segments for the year 2022”, “for all advertising campaigns during the year 2022, which audience age group segment performed best?”, and the like. In some embodiments, user interface 502 comprises a voice interface and the user may speak natural language requests using interface 502.

At 404, campaign reporting system 500 (using campaign LLM 506) may convert the natural language request to a suitable query. A suitable query may be understood to include any request to retrieve or manipulate information (e.g., structured or unstructured data) that is expressed in a language and format sufficient to execute on the data store being queried. In some embodiments, campaign LLM 506 is configured to generate suitable queries for any type of data store (e.g., SQL, NoSQL, HQL, etc.) that is communicatively coupled to campaign LLM 506.

With continued reference to 404 of FIG. 4, campaign LLM 506 may convert the natural language request by, for example, encoding the user query, identifying entities and intent from the query, matching them with the available data in data store 508, and generating (decoding) one or more database queries (e.g., SQL, NoSQL, HQL, etc.) to retrieve the relevant information from the underlying data in data store 508.

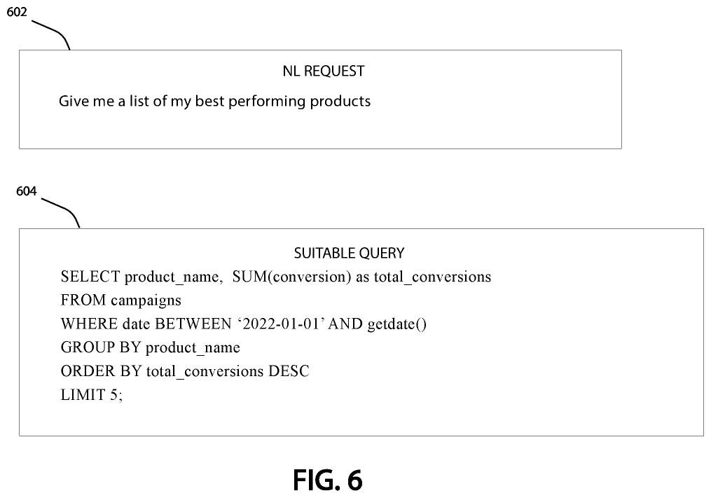

Reference is now made to FIG. 6 to further describe step 404. In FIG. 6 is shown an illustration of an exemplary natural language request 602 and an exemplary suitable SQL query 604 that may be generated by campaign LLM 506 and that may correspond to request 602. As may be appreciated from this illustration, in encoding suitable query 604 from request 602, campaign LLM 506 identified entities relevant to the request (e.g., fields “product_name” and “conversion”, table “campaigns”, etc.) and identified a user intent (e.g., to provide a listing of the top five best performing product advertisements, as measured by conversions, since the beginning of the year and list them in descending order), as evidenced by, e.g., the operations performed on the identified entities/data (SUM, GROUP BY, WHERE, ORDER BY, DESC, LIMIT 10).

With continued reference to 404 of FIG. 4, as may be appreciated, in encoding suitable queries for any particular user requests, campaign LLM 506 may encode one or more queries that are different and/or more complex than the SQL query illustrated by 604. Some non-limiting examples may include SQL, HQL, etc. queries that involve, e.g., joining tables (objects, documents, etc.) and performing aggregations, compares, averages, etc. over them.

At 406, campaign reporting system 500 may execute the suitable query and/or queries on data store 508 and retrieves the output. In some embodiments, campaign LLM 506 causes the query to be executed at data store 508 using, e.g., an API or in more tightly integrated embodiments using DBMS commands.

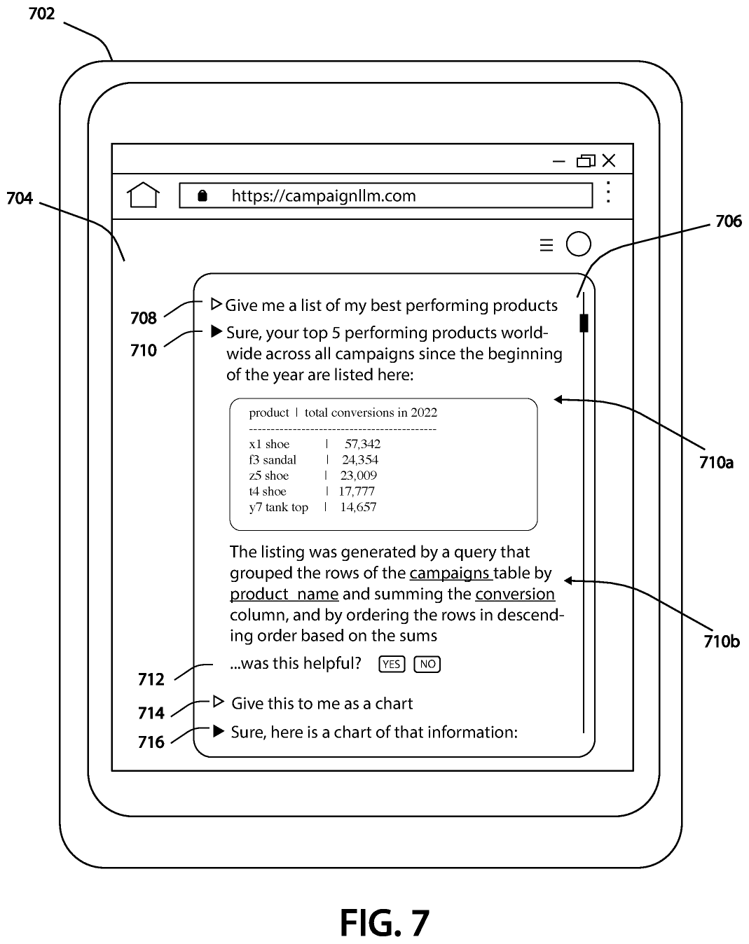

At 408, campaign reporting system 500 (using campaign LLM 506) may encode the relevant information retrieved from the one or more queries, along with the user initial request and/or query, and generate (decode) a suitable natural language response. Reference is made to FIG. 7 to further describe step 408. In FIG. 7 is shown an illustration of an exemplary client computing device 702 accessing an example of a web page (or application) 704 for which campaign reporting system 500 may be enabled, and on which an exemplary embodiment of user interface 502 may be displayed. For example, user interface 502 may provide a chat-type window element 706 on page 704 for a user to utilize and interact via natural language text requests with campaign LLM 506. In the exemplary embodiment, a user has typed previously described request 602 at user prompt 708 of element 706. As shown, an example of a suitable response from campaign LLM 506 is provided at prompt 710. As may be seen, the response at 710 is tailored or suited to the user's natural language request, based upon, e.g., relevant query output retrieved at step 406 (e.g., product names, product information (conversion data), etc.) and initial request and query information (e.g., contextual information from the initial request encoded into the query by catalog LLM 506 regarding, e.g., user intention-time range, geographic scope, performance statistic (conversions), size of the list, etc.). For example, at response portion 710a, catalog LLM 506 generated a natural language description accurately summarizing the relevant query response data and set forth the requested list in table format. Additionally, in some embodiments catalog LLM 506 may include a natural language description (shown at response portion 710b) of the query and/or data retrieval process. In some embodiments, catalog LLM 506 may include code for the query or queries (e.g., shown at 604) or a link thereto.

In some embodiments, as shown in FIG. 7, responses from catalog LLM 506 may include a user feedback request regarding the accuracy or suitability of the response, such as the feedback request shown at portion 712. Such embodiments of campaign reporting system 500 may be configured to continually train or tune catalog LLM 506 based on user feedback responses.

With reference again to FIG. 4, at 410, which is optional, in some embodiments the user may submit one or more consecutive requests for, e.g., clarification or fine tuning, and the system may take the previous context into account when responding. As illustrated in FIG. 7, at portion 714, an example of a consecutive request by the user is shown, requesting a chart. An example of a consecutive response by catalog LLM 506 is set forth at 716. As may be seen, catalog LLM 506 may take into account any previous contextual information from conversation, back to the initial user request.

In some embodiments, campaign LLM 506 may comprise a plurality of dedicated LLMs. In some embodiments, campaign LLM 506 comprises a first dedicated LLM particularly designed for handling user natural language requests and a second dedicated LLM particularly designed for generating suitable natural language responses to such requests. For example, in some embodiments campaign LLM 506 comprises a first dedicated LLM trained on one or more large data sets selected to create a dedicated campaign LLM that is tailored to encode queries (e.g., query 604) from user natural language requests (e.g., request 602), and a second dedicated campaign LLM that is tailored to generate/decode suitable natural language responses (e.g., responses 710, 716) to such requests.

In some embodiments, campaign LLM 506 comprises one or more federated LLMs. In such embodiments, federation may be implemented by, e.g., training different instances of campaign LLM 506 with different user data (e.g., user query and feedback information) and thereby result in instances of campaign reporting system 500 that are personal to each user and that may, for example, generate responses that are particularly suited to each user by, for example, incorporating prior response context from prior conversations.

With reference to FIG. 4, at 412, which is optional, in some embodiments the user may submit a request for insights or recommendations and receive natural language responses from system 500. Non-limiting examples of such requests may include: “What should I do to increase content interactions from user segment X?”, “what should I do to increase post-click conversions in January?”, etc. In some embodiments, system 500 may provide responses based on patterns it observes from all or portions of data in data store 506, as well as, in some embodiments in data sets external to system 500.

It may be appreciated that the disclosed subject matter may assist a user (e.g., and/or a client device associated with the user) in creating and running queries on data stores using only natural language requests, regardless of the data store environment (e.g., NoSQL vs SQL). Alternatively and/or additionally, the disclosed subject matter may assist the user in obtaining insights and recommendations relating to their data (campaign related data) based on generative AI techniques and taking into account the context of the user's natural language request(s).

Alternatively and/or additionally, implementation of at least some of the disclosed subject matter may enable a computer (e.g., a computer on which at least some of the content system is implemented) to automatically and intelligently produce database specific queries based on a user's natural language requests, and in particular, campaign related queries.

Alternatively and/or additionally, implementation of at least some of the disclosed subject matter may lead to benefits including increasing an accuracy and/or precision in data mining on campaign related data and generating meaningful insights from the data in a natural language format.

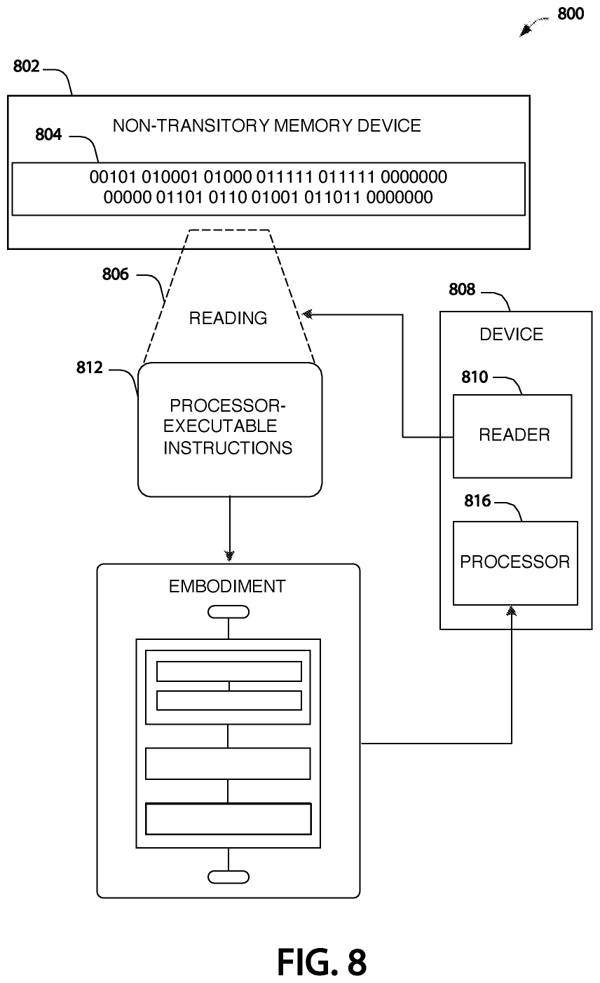

FIG. 8 is an illustration of a scenario 800 involving an example non-transitory machine readable medium 802. The non-transitory machine readable medium 802 may comprise processor-executable instructions 812 that when executed by a processor 816 cause performance (e.g., by the processor 816) of at least some of the provisions herein. The non-transitory machine readable medium 802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 702 stores computer-readable data 804 that, when subjected to reading 806 by a reader 810 of a device 808 (e.g., a read head of a hard disk drive, or a read operation invoked on a solid-state storage device), express the processor-executable instructions 812. In some embodiments, the processor-executable instructions 812, when executed cause performance of operations, such as at least some of the example method 400 of FIG. 4, for example. In some embodiments, the processor-executable instructions 812 are configured to cause implementation of a system, such as at least some of the example system 500 of FIG. 5, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” and/or the like is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In some embodiments, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. An interactive reporting system, comprising:
a user interface configured to receive a natural language request and to display information responsive to the natural language request;
a data store containing a data set; and
a serving system communicatively coupled to the data store comprising a dedicated campaign large language model (LLM), configured to
convert the natural language request to a query capable of being run against the data set and to run the query against the data set,
receive output from the query,
encode at least one of the output, the natural language request, or the query into an encoded output, and
decode the encoded output to generate a natural language response to the natural language request.

2. The interactive reporting system of claim 1, wherein the dedicated campaign LLM comprises a dedicated transformer type large language model created through training on one or more large campaign related data sets.

3. The interactive reporting system of claim 1, wherein the dedicated campaign LLM comprises a first dedicated LLM trained on one or more first large campaign data sets selected to create a first dedicated campaign LLM tailored to encode queries from first user natural language requests, and a second dedicated campaign LLM trained on one or more second large campaign data sets selected to create a second dedicated campaign LLM tailored to generate natural language responses to second user natural language requests.

4. The interactive reporting system of claim 1, wherein the dedicated campaign LLM comprises a federated LLM in which each federation has been created via training on an individual user data set that is characteristic of and unique to an individual user corresponding to the individual user data set.

5. The interactive reporting system of claim 4, wherein each individual user data set comprises prior natural language requests, query information, and feedback information corresponding to the individual user.

6. The interactive reporting system of claim 1, wherein the data store warehouses campaign related data.

7. The interactive reporting system of claim 1, wherein the user interface comprises a client device configured to provide a screen having a chat-type window element.

8. A method, comprising:
receiving, via a user interface of a campaign reporting system, a natural language request;
converting, by a campaign large language model (LLM) of the campaign reporting system, the natural language request to a query;
executing, by the campaign reporting system, the query on a data store of the campaign reporting system;
retrieving, by the campaign reporting system, output of the query;
encoding, by the campaign LLM, the output, the natural language request, and the query into an encoded output;
generating, by the campaign reporting system, a natural language response to the natural language request from the encoded output; and
displaying, by the campaign reporting system, the natural language response on the user interface of the campaign reporting system.

9. The method of claim 8, comprising: receiving, via the user interface, one or more consecutive natural language requests to the campaign reporting system for at least one of clarification or fine tuning.

10. The method of claim 8, comprising receiving, via the user interface, one or more natural language requests for insight.

11. The method of claim 8, wherein the campaign LLM comprises a dedicated transformer type large language model created through training on one or more large campaign related data sets.

12. The method of claim 8, wherein the campaign LLM comprises a first dedicated LLM trained on one or more first large campaign data sets selected to create a first dedicated campaign LLM tailored to encode queries from first user natural language requests, and a second dedicated campaign LLM trained on one or more second large campaign data sets selected to create a second dedicated campaign LLM tailored to generate natural language responses to second user natural language requests.

13. The method of claim 8, wherein the campaign LLM comprises a federated LLM in which each federation has been created via training on an individual user data set that is characteristic of and unique to an individual user corresponding to the individual user data set.

14. The method of claim 8, wherein the user interface comprises a client device configured to provide a screen having a chat-type window element.

15. A non-transitory machine readable medium having stored thereon processor-executable instructions that when executed cause performance of operations, the operations comprising:
receiving, via a user interface of a campaign reporting system, a natural language request;
converting, by a campaign large language model (LLM) of the campaign reporting system, the natural language request to a query;
executing, by the campaign reporting system, the query on a data store of the campaign reporting system;
retrieving, by the campaign reporting system, the output of the query;
encoding, by the campaign LLM, at least one of the output, the natural language request, and the query into an encoded output;
generating, by the campaign reporting system, a natural language response to the natural language request from the encoded output; and
displaying, by the campaign reporting system, the response on the user interface of the campaign reporting system.

16. The non-transitory machine readable medium of claim 15, wherein the operations comprise receiving, via the user interface, one or more consecutive natural language requests to the campaign reporting system for at least one of clarification or fine tuning.

17. The non-transitory machine readable medium of claim 15, wherein the operations comprise receiving, via the user interface, one or more natural language natural language requests for insight.

18. The non-transitory machine readable medium of claim 15, wherein the campaign LLM comprises a dedicated transformer type large language model created through training on one or more large campaign related data sets.

19. The non-transitory machine readable medium of claim 15, wherein the campaign LLM comprises a federated LLM in which each federation has been created via training on an individual user data set that is characteristic of and unique to an individual user corresponding to the individual data set.

20. The non-transitory machine readable medium of claim 15, wherein the user interface comprises a client device configured to provide a screen having a chat-type window element.
